(19) United States
(12) Patent Application Publication
(10) Pub. No.: US 2026/0122705 A1
(43) Pub. Date: Apr. 30, 2026

(54) COMMUNICATION METHOD, COMMUNICATIONS APPARATUS, COMMUNICATIONS DEVICE, AND ACCESS NETWORK ARCHITECTURE

(71) Applicant: GUANGDONG OPPO MOBILE TELECOMMUNICATIONS CORP., LTD., Dongguan (CN)

(72) Inventors: Shukun WANG, Dongguan (CN); Zhongda DU, Dongguan (CN); Cong SHI, Dongguan (CN)

(73) Assignee: GUANGDONG OPPO MOBILE TELECOMMUNICATIONS CORP., LTD., Dongguan (CN)

(21) Appl. No.: 19/003,231

(22) Filed: Dec. 27, 2024

Related U.S. Application Data
(63) Continuation of application No. PCT/CN2022/105535, filed on Jul. 13, 2022.

(51) Int. Cl. H04W 76/15; H04W 76/22; H04W 80/02

(52) U.S. Cl. CPC H04W 76/15; H04W 76/22; H04W 80/02

(57) ABSTRACT

Embodiments of this application provide a communication method, a communications apparatus, a communications device, and an access network architecture, where the method includes: receiving, by a first node, data transmitted by a terminal device, performing transmission-related processing on received data by using a first protocol stack, and transmitting the processed data to a second node; and/or, receiving, by a first node, data transmitted by a second node, performing transmission-related processing on the received data by using a first protocol stack, and transmitting the processed data to a terminal device.

### CROSS-REFERENCE TO RELATED APPLICATIONS

This application is a continuation of International Application No. PCT/CN2022/105535, filed on Jul. 13, 2022, the disclosure of which is hereby incorporated by reference in its entirety.

### TECHNICAL FIELD

Embodiments of this application relate to the field of mobile communications technologies, and specifically, to a communication method, a communications apparatus, a communications device, and an access network architecture.

### RELATED ART

In an access network architecture, hybrid networking of a low frequency, a high frequency, and an ultra-high frequency will be applied in future networking. High-frequency cells and ultra-high-frequency cells are characterized by fast signal fading, small cell coverage, and dense deployment of small cells.

### SUMMARY

Embodiments of this application provide a communication method, a communications apparatus, a communications device, an access network architecture, a chip, a computer-readable storage medium, a computer program product, and a computer program.

A communication method according to an embodiment of this application is applied to a first node in an access network architecture, where the first node is associated with a second node, the first node has a first protocol stack, the first protocol stack is a transmission-related protocol stack, the second node has a second protocol stack, and the second protocol stack is a bearer-related protocol stack; and the method includes:
receiving, by the first node, data transmitted by a terminal device, performing transmission-related processing on the received data by using the first protocol stack, and transmitting the processed data to the second node; and/or
receiving, by the first node, data transmitted by the second node, performing transmission-related processing on the received data by using the first protocol stack, and transmitting the processed data to a terminal device.

A first node is provided according to an embodiment of this application. The first node is arranged in an access network architecture, where the first node is associated with a second node, the first node has a first protocol stack, the first protocol stack is a transmission-related protocol stack, the second node has a second protocol stack, and the second protocol stack is a bearer-related protocol stack; and the first node includes a processor and a memory, the memory is configured to store a computer program, and the processor is configured to execute the computer program stored in the memory to cause the first node to perform a method including:
receiving data transmitted by a terminal device; performing transmission-related processing on the received data by using the first protocol stack; and transmitting the processed data to the second node; and/or
receiving data transmitted by the second node; performing transmission-related processing on the received data by using the first protocol stack; and transmitting the processed data to a terminal device.

### BRIEF DESCRIPTION OF DRAWINGS

The accompanying drawings described herein are used to provide a further understanding of this application, and constitute a part of this application. A schematic embodiment of this application and descriptions thereof are used to explain this application, and do not constitute an improper limitation of this application. In the accompanying drawings:

FIG. 1 is a schematic diagram of a process of RRC connection setup and bearer setup.

FIG. 2 is a schematic diagram of an access network architecture according to an embodiment of this application.

FIG. 3 is a schematic diagram of a GTP tunnel between an AP and a CCN according to an embodiment of this application.

FIG. 4 is a schematic flowchart of a communication method according to an embodiment of this application.

FIG. 5 is a schematic diagram of a process of connection setup and bearer setup corresponding to a case 1 according to an embodiment of this application.

FIG. 6 is a schematic diagram of a process of connection setup and bearer setup corresponding to a case 4 according to an embodiment of this application.

FIG. 7 is a schematic diagram of a process of connection setup and bearer setup corresponding to a case 3 according to an embodiment of this application.

FIG. 8 is a schematic diagram of a process of connection setup and bearer setup corresponding to a case 2 according to an embodiment of this application.

FIG. 9 is a schematic structural diagram 1 of a communications apparatus according to an embodiment of this application.

FIG. 10 is a schematic structural diagram 2 of a communications apparatus according to an embodiment of this application.

FIG. 11 is a schematic structural diagram of a communications device according to an embodiment of this application.

FIG. 12 is a schematic structural diagram of a chip according to an embodiment of this application.

FIG. 13 is a schematic block diagram of a communications system according to an embodiment of this application.

### DESCRIPTION OF EMBODIMENTS

To facilitate understanding of the technical solutions in embodiments of this application, the following describes related technologies in embodiments of this application. The following related technologies may be randomly combined with the technical solutions in embodiments of this application as optional solutions, which all fall within the protection scope of embodiments of this application.

It should be noted that, the terms “system” and “network” may often be used interchangeably herein. In this specification, the term “and/or” is merely an association that describes associated objects, and represents that there may be three relationships. For example, A and/or B may represent three cases: only A exists, both A and B exist, and only B exists. In addition, the character “/” herein generally indicates an “or” relationship between the associated objects. It should be further understood that, the “indication” mentioned in embodiments of this application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association between A and B. It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like.

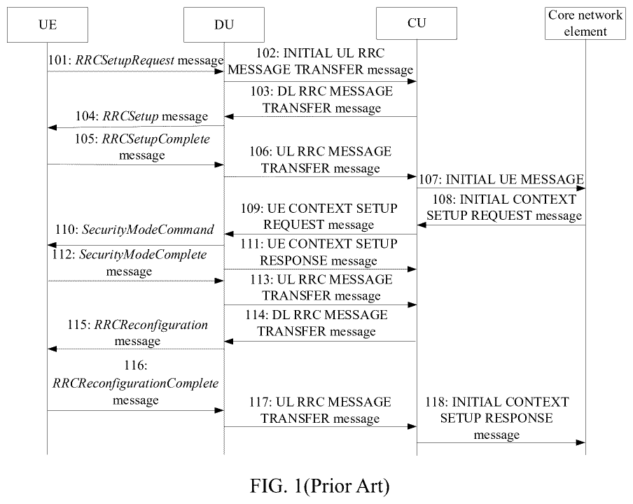

In new radio (New Radio, NR), an architecture in which a distributed unit (Distributed Unit) is separated from a centralized unit (CU), that is, a DU-CU separation architecture, is introduced into a base station. In the DU-CU separation architecture, a service data adaptation protocol (SDAP) entity and a packet data convergence protocol (PDCP) entity are located in the CU, and a radio link control (RLC) entity, a medium access control (MAC) entity, and a physical (PHY) entity are located in the DU. In a process in which a terminal device performs intra-CU (intra-CU) handover, a key may not be updated because the PDCP entity does not change. Therefore, operations such as PDCP re-setup are not required, thereby greatly reducing a data packet loss rate in the handover process, improving performance of the handover, and providing a basis for cloudification of a radio access network (RAN). In future network deployment, RAN cloudification becomes a major trend. In the DU-CU separation architecture, a radio resource control (RRC) entity is located in the CU. In an access network architecture, hybrid networking of a low frequency, a high frequency, and an ultra-high frequency will be applied in future networking. High-frequency cells and ultra-high-frequency cells are characterized by fast signal fading, small cell coverage, and dense deployment of small cells. These features cause frequent cell handover of a terminal device in a moving process, and the frequent cell handover results in problems such as packet loss and service interruption, which ultimately affect user experience. A process of RRC connection setup and bearer setup is shown in FIG. 1, and includes the following steps 101 to 118.

In step 101, a UE transmits an RRC setup request message to the DU.

Herein, the RRC setup request message is an RRCSetupRequest message.

In step 102, the DU performs an initial uplink RRC message transfer to the CU.

Herein, the initial uplink RRC message transfer is an INITIAL UL RRC MESSAGE TRANSFER.

In step 103, the CU performs a downlink RRC message transfer to the DU.

Herein, the downlink RRC message transfer is a DL RRC MESSAGE TRANSFER, and this message is used to establish a wireless resource for the UE.

In step 104, the DU transmits an RRC setup message to the UE.

Herein, the RRC setup message is an RRCSetup message.

In step 105, the UE transmits an RRC setup complete message to the DU.

Herein, the RRC setup complete message is an RRCSetupComplete message.

In step 106, the DU performs an uplink RRC message transfer to the CU.

Herein, the uplink RRC message transfer is a UL RRC MESSAGE TRANSFER.

In step 107, the CU transmits an initial UE message to a core network element.

Herein, the initial UE message is an INITIAL UE MESSAGE message.

In step 108, the core network element transmits an initial context setup request message to the CU.

Herein, the initial context setup request message is an INITIAL CONTEXT SETUP REQUEST message.

In step 109, the CU transmits a UE context setup request message to the DU.

Herein, the UE context setup request message is a UE CONTEXT SETUP REQUEST message.

In step 110, the DU transmits a security mode command to the UE.

Herein, the security mode command is SecurityMode Command.

In step 111, the DU transmits a UE context setup response message to the CU.

Herein, the UE context setup response message is a UE CONTEXT SETUP RESPONSE message.

In step 112, the UE transmits a security mode complete message to the DU.

Herein, the security mode complete message is a SecurityModeComplete message.

In step 113, the DU performs an uplink RRC message transfer to the CU.

Herein, the uplink RRC message transfer is a UL RRC MESSAGE TRANSFER.

In step 114, the CU performs a downlink RRC message transfer to the DU.

Herein, the downlink RRC message transfer is a DL RRC MESSAGE TRANSFER.

In step 115, the DU transmits an RRC reconfiguration message to the UE.

Herein, the RRC reconfiguration message is an RR (Reconfiguration message.

In step 116, the UE transmits an RRC reconfiguration complete message to the DU.

Herein, the RRC reconfiguration complete message is an RROReconfigurationComplete message.

In step 117, the DU performs an uplink RRC message transfer to the CU.

Herein, the uplink RRC message transfer is a UL RRC MESSAGE TRANSFER.

In step 118, the CU transmits an initial context setup response message to the core network element.

Herein, the initial context setup response message is an INITIAL CONTEXT SETUP RESPONSE message.

In the foregoing solution, the DU and the CU are two physical entities that belong to the base station.

In the foregoing solution, the core network element may be an access and mobility management function (Access and Mobility Management Function, AMF).

In future mobile communications systems (for example, a 6G system), hybrid networking of a low frequency, a high frequency, and an ultra-high frequency will be applied in future networking. High-frequency cells and ultra-high-frequency cells are characterized by fast signal fading, small cell coverage, and dense deployment of small cells. These features cause frequent cell handover of a terminal device in a moving process, and the frequent cell handover results in problems such as packet loss and service interruption, which ultimately affect user experience. Therefore, in design of a future mobile communications system, the features of the high-frequency cells and the ultra-high-frequency cells need to be considered. Therefore, the technical solutions in embodiments of this application are proposed.

To facilitate understanding of the technical solutions in embodiments of this application, the following describes the technical solutions in this application in detail by using specific embodiments. The foregoing related technologies, as optional solutions, may be randomly combined with the technical solutions in embodiments of this application, all of which fall within the protection scope of embodiments of this application. Embodiments of this application include at least a part of the following content.

It should be noted that the technical solutions in embodiments of this application may be applied to a future mobile communications system, for example, a 6G system.

An embodiment of this application provides a new access network architecture, where the access network architecture includes a second node and at least one node associated with the second node, any node in the at least one node has a first protocol stack, the first protocol stack is a transmission-related protocol stack, the second node has a second protocol stack, the second protocol stack is a bearer-related protocol stack, where one of the nodes associated with the second node is a first node.

Herein, the first node may be an access point (AP) or a radio transport point (RTP). The second node may be referred to as a central control node (CCN). Certainly, the first node may also have another implementation, and the second node may also have another name, which is not limited in this application.

In some implementations, implementation of the first protocol stack and the second protocol stack may include but is not limited to the following manners 1 to 4.

In manner 1, the first protocol stack includes a MAC entity and a PHY entity, and the second protocol stack includes at least one of the following: an SDAP entity, a PDCP entity, or an RLC entity.

In manner 2, the first protocol stack includes a PHY entity, and the second protocol stack includes at least one of the following: an SDAP entity, a PDCP entity, an RLC entity, or a MAC entity.

In manner 3, the first protocol stack includes a MAC entity and a PHY entity, and the second protocol stack includes at least one of the following: an SDAP entity or a target entity, where the target entity has at least some of functions of a PDCP entity and/or an RLC entity.

In manner 4, the first protocol stack includes a PHY entity, and the second protocol stack includes at least one of the following: an SDAP entity, a target entity, or a MAC entity, where the target entity has at least some of functions of a PDCP entity and/or an RLC entity.

In the foregoing solution, for details on functions of a PHY entity, a MAC entity, an SDAP entity, a PDCP entity, and an RLC entity, one may refer to definitions in a current standard.

In the foregoing solution, the target entity is a newly defined entity, and the target entity has at least some of functions of a PDCP entity and/or an RLC entity. For example, a function of the target entity is a combination of a function of the PDCP entity and a function of the RLC entity. The target entity may be referred to as a packet processing and link control (PPLC) entity. Certainly, the target entity may also have another name, which is not limited in this application. The target entity has a plurality of modes, where the plurality of modes includes a first mode, a second mode, and a third mode. Herein, the first mode may be referred to as an acknowledgment mode (AM), the second mode may be referred to as an unacknowledgment mode (UM), and the third mode may be referred to as a transparent transmission mode (TM). Certainly, the first mode, the second mode, and the third mode may also have other names, which are not limited in this application. The following separately describes functions of the target entity in the first mode, the second mode, and the third mode.

Option (1): In some implementations, a function of the target entity with the first mode includes at least one of the following: an integrity protection function, an encryption and decryption function, a header compression function, an automatic repeat request (ARQ) function, a serial number (SN) and reordering function, or a segmentation function. A function of the target entity with the second mode includes at least one of the following: an integrity protection function, an encryption and decryption function, a header compression function, an SN and reordering function, or a segmentation function. A function of the target entity with the third mode includes at least a transparent transmission function.

Option (2): In some implementations, a function of the target entity with the first mode includes at least one of the following: an integrity protection function, an encryption and decryption function, an ARQ function, an SN and reordering function, or a segmentation function. A function of the target entity with the second mode includes at least one of the following: an integrity protection function, an encryption and decryption function, an SN and reordering function, or a segmentation function. A function of the target entity with the third mode includes at least a transparent transmission function. Herein, the SDAP entity above the target entity has at least a header compression function.

Option (3): In some implementations, a function of the target entity with the first mode includes at least one of the following: an ARQ function, an SN and reordering function, or a segmentation function. A function of the target entity with the second mode includes at least one of the following: an SN and reordering function or a segmentation function. A function of the target entity with the third mode includes at least a transparent transmission function. Herein, the SDAP entity above the target entity has at least one of the following functions: an integrity protection function, an encryption and decryption function, or a header compression function.

In the foregoing solution, the manner 3 may be understood as a variation solution of the manner 1. A difference between the manner 3 and the manner 1 lies in that the second protocol stack in the manner 3 includes at least one of an SDAP entity or a target entity, while the second protocol stack in the manner 1 includes at least one of a PDCP entity, an RLC entity, or a MAC entity.

In the foregoing solution, the manner 4 may be understood as a variation solution of the manner 2. A difference between the manner 4 and the manner 2 lies in that the second protocol stack in the manner 4 includes at least one of an SDAP entity, a target entity, or a MAC entity, while the second protocol stack in the manner 2 includes at least one of an SDAP entity, a PDCP entity, an RLC entity, or a MAC entity.

In some implementations, in a case in which the first protocol stack includes a MAC entity (corresponding to the foregoing solutions of the manner 1 and the manner 3), a tunnel used for data transmission between the first node and the second node is at a logical channel level (per logical channel) or at a data bearer level (per DRB). Herein, one or more tunnels are established between the first node and the second node, and a tunnel ID of each tunnel is associated with one logical channel ID or one data bearer ID. Herein, optionally, the tunnel may be a GTP tunnel, a tunnel ID of the GTP tunnel is a TEID or a TEID pair, and a TEID or a TEID pair of each GTP tunnel is associated with one logical channel ID (LCID) or one data bearer ID (DRB ID). Each tunnel between the first node and the second node is configured to transmit data of one logical channel or one data bearer.

In some implementations, in a case in which the first protocol stack does not include a MAC entity (corresponding to the foregoing solutions of the manner 2 and the manner 4), a tunnel used for data transmission between the first node and the second node is at a terminal device level, at a MAC entity level, or at a PDU session level. A MAC PDU (that is, a MAC TB) is transmitted between the first node and the second node. Herein, one or more tunnels are established between the first node and the second node, and a tunnel ID of each tunnel is associated with a terminal device ID, a MAC entity ID, or a PDU session ID. Each tunnel between the first node and the second node is configured to transmit data of one terminal device, one MAC entity, or one PDU session. Further, optionally, in a case in which the tunnel used for data transmission is at a terminal device level or at a MAC entity level, a MAC header corresponding to the data includes a PDU session ID and/or a MAC entity ID.

In this embodiment of this application, the first node further has a first RRC entity, and the second node further has a second RRC entity; or the first node does not have a first RRC entity, and the second node further has a second RRC entity.

In some implementations, in a case in which the first node has a first RRC entity, the first RRC entity is configured to process first-type RRC signalling, the second RRC entity is configured to process second-type RRC signalling, the first-type RRC signalling is RRC signalling related to a transmission configuration, and the second-type RRC signalling is RRC signalling related to a bearer.

In some implementations, in a case in which the first node does not have a first RRC entity, the second RRC entity is configured to process first-type RRC signalling and second-type RRC signalling, where the first-type RRC signalling is RRC signalling related to a transmission configuration, and the second-type RRC signalling is RRC signalling related to a bearer.

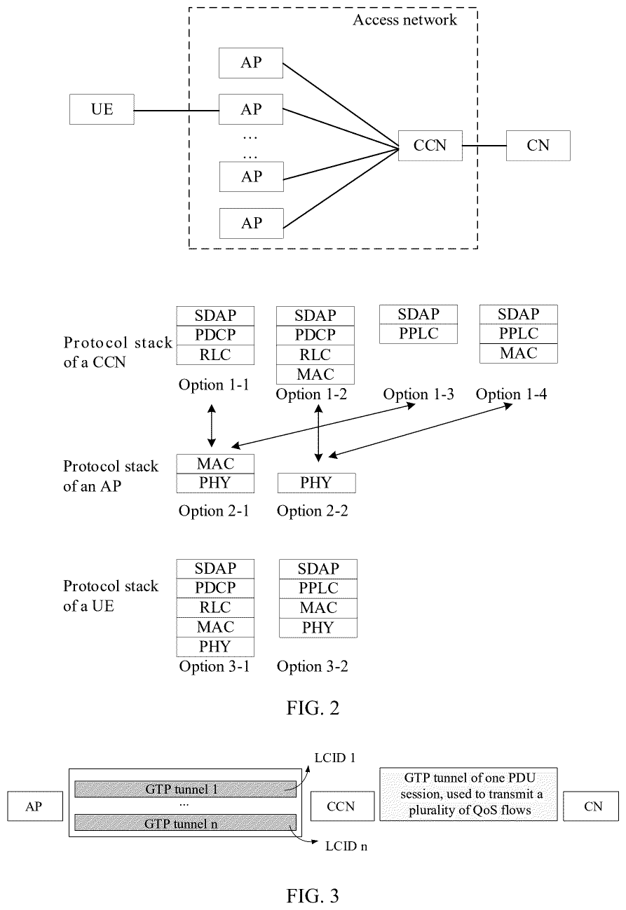

In an example, FIG. 2 provides an access network architecture. As shown in FIG. 2, a first node is an AP and a second node is a CCN, for example. A plurality of APs may communicate with the CCN in a wireless or wired manner, a UE may communicate with the AP by using an air interface, and data may be transmitted between the CCN and a core network (Core Network, CN) over a GTP tunnel. The CCN is configured to perform data processing related to an upper-layer service, that is, data processing related to a bearer. Implementation of a protocol stack of the CCN includes the following options: option 1-1: an SDAP entity, a PDCP entity, and an RLC entity; option 1-2: an SDAP entity, a PDCP entity, an RLC entity, and a MAC entity; option 1-3: an SDAP entity and a PPLC entity; and option 1-4: an SDAP entity, a PPLC entity, and a MAC entity. The AP is configured to perform processing of underlying data transmission (that is, processing of air interface data transmission), and implementation of a protocol stack of the AP includes the following options: option 2-1: a MAC entity and a PHY entity; and option 2-2: a PHY entity. Option 2-1 may be implemented in combination with option 1-1 or option 1-3, and option 2-2 may be implemented in combination with option 1-2 or option 1-4. In addition, implementation of a protocol stack of the UE has the following options: option 3-1: an SDAP entity, a PDCP entity, an RLC entity, a MAC entity, and a PHY entity; and option 3-2: an SDAP entity, a PPLC entity, a MAC entity, and a PHY entity. One CCN may manage a large quantity of APs, and one AP may be one logical cell or a plurality of logical cells. When the UE is handed over to an AP in a different domain, a bearer-related configuration may not be reconfigured, and even an RRC configuration may not be required. Instead, cell updating is directly performed in response to a command based on a layer 1 (L1) or a layer 2 (L2). In this way, service processing can be decoupled from data transmission, thereby reducing a service processing configuration change caused by an AP change.

It should be noted that the access network architecture shown in FIG. 2 shows only one CCN and a plurality of APs associated with the CCN, but is not limited thereto. The access network architecture may include a larger quantity of CCNs, and one or more APs may be associated with each CCN.

When the AP and the CCN jointly form an access network, an RRC entity may also exist on the AP, and an RRC entity may also exist on the CCN. In this case, the RRC entity on the AP may be configured to process RRC signalling (for example, RRC signalling related to an underlying transmission resource) related to a transmission configuration, such as RRC signalling that carries broadcast information, RRC signalling that carries a MSG3, RRC signalling that carries a physical-side resource (for example, an underlying resource) reconfiguration, and RRC signalling that carries carrier management (for example, carrier addition, deletion, or modification) information in CA. The RRC entity on the CCN may be configured to process RRC signalling related to a bearer, and the like. Alternatively, an RRC entity may not exist on the AP, and an RRC entity exists only on the CCN. In this case, the RRC entity on the CCN is configured to process all RRC signalling (such as RRC signalling related to a transmission configuration and RRC signalling related to a bearer). Depending on whether an RRC entity exists on the AP and whether a MAC entity exists on the AP, there may be four cases shown in the following Table 1.

TABLE 1

| | Whether an RRC entity | Whether a MAC entity |
|---|---|---|
| | exists on the AP | exists on the AP |
| Case | Yes | Yes |
| 1 | The RRC entity on the AP is | A tunnel between the AP |
| | configured to process RRC signalling | and the CCN for data |
| | related to a transmission configuration, | transmission is at a |
| | and the RRC signalling is transparent | logical channel level |
| | to the CCN. The RRC entity on the | or at a DRB level. |
| | CCN is configured to process RRC | |
| | signalling related to a bearer, and | |
| | the RRC signalling is transparent | |
| | to the AP. | |
| Case | No | No |
| 2 | The RRC entity on the CCN is | A tunnel between the AP |
| | configured to process all RRC | and the CCN for data |
| | signalling, including RRC signalling | transmission is at a UE |
| | related to a transmission configuration, | level, at a MAC entity |
| | RRC signalling related to a bearer, | level, or at a PDU |
| | and the like. | session level. |
| Case | Yes | No |
| 3 | The RRC entity on the AP is configured | A tunnel between the AP |
| | to process RRC signalling related to a | and the CCN for data |
| | transmission configuration, and the | transmission is at a UE |
| | RRC signalling is transparent to the | level, at a MAC entity |
| | CCN. The RRC entity on the CCN is | level, or at a PDU |
| | configured to process RRC signalling | session level. |
| | related to a bearer, and the RRC | |
| | signalling is transparent to the AP. | |
| Case | No | Yes |
| 4 | The RRC entity on the CCN is | A tunnel between the AP |
| | configured to process all RRC | and the CCN for data |
| | signalling, including RRC signalling | transmission is at a |
| | related to a transmission configuration, | logical channel level or |
| | RRC signalling related to a bearer, | at a DRB level. |
| | and the like. | |

In a case in which the AP includes a MAC entity and a PHY entity, a GTP tunnel per logical channel is established between the AP and the CCN, that is, a TEID or a TEID pair of each GTP tunnel is associated with one LCID. As shown in FIG. 3, each GTP tunnel is used to transmit data of one logical channel.

In a case in which the AP includes a PHY entity, a GTP tunnel per UE, per MAC entity, or per PDU session is established between the AP and the CCN, that is, a TEID or a TEID pair of each GTP tunnel is associated with one UE ID, one MAC entity ID, or one PDU session ID, and each GTP tunnel is configured to transmit data of one UE, one MAC entity, or one PDU session. Further, for a GTP tunnel per UE or per MAC entity, a MAC header corresponding to data includes a PDU session ID and/or a MAC entity ID.

In some implementations, the second node belongs to a node pool, and all nodes in the node pool are connected to a same core network node. If the second node is faulty, all control plane connections and/or user plane connections under the second node are transferred to a fourth node in the node pool. Herein, each of a tunnel ID and a signalling connection ID allocated to the second node is unique in the node pool.

Herein, the second node is referred to as a CCN and the first node is referred to as an AP, for example. The node pool may be referred to as a CCN pool (CCN pool), and the CCN pool may be understood as a CCN set formed by a plurality of CCNs. All CCNs that belong to one CCN pool are connected to a same core network node. If one CCN is faulty, all control plane connections and/or user plane connections with the AP under the CCN are transferred to another CCN in the CCN pool to which the CCN belongs. This is not perceived by a UE that accesses the AP and therefore does not affect the UE. Because control plane connections and/or user plane connections that belong to different CCNs in the CCN pool may be transferred to each other, a GTP tunnel ID (TEID) allocated to a CCN is unique in the CCN pool, and a signalling connection ID (for example, an APID) allocated to a CCN is also unique in the CCN pool. In this manner, when one CCN is faulty, an AP under the CCN may connect to another CCN and therefore operate normally, thereby ensuring good user experience.

The following describes a communication method according to embodiments of this application with reference to the foregoing access network architecture.

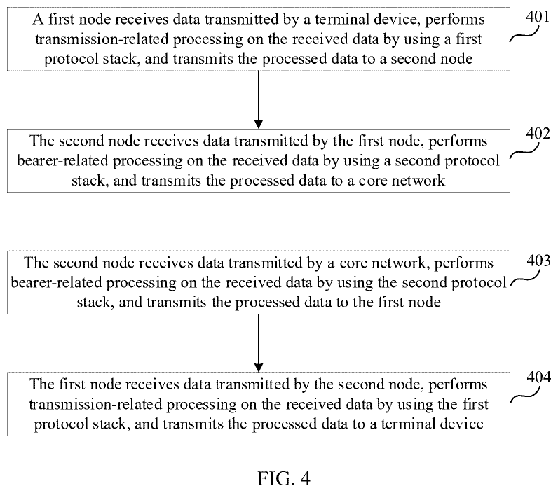

FIG. 4 is a schematic flowchart of a communication method according to an embodiment of this application, applied to a first node and/or a second node in an access network architecture, where the first node is associated with the second node, the first node has a first protocol stack, the first protocol stack is a transmission-related protocol stack, the second node has a second protocol stack, and the second protocol stack is a bearer-related protocol stack. As shown in FIG. 4, the communication method includes at least one of the following steps 401 to 404.

In step 401, the first node receives data transmitted by a terminal device, performs transmission-related processing on the received data by using the first protocol stack, and transmits the processed data to the second node.

In some implementations, in a case in which implementation of the first protocol stack and the second protocol stack is the foregoing manner 1 or manner 3; after performing the transmission-related processing on the received data by using the first protocol stack, the first node determines a tunnel corresponding to the data based on a logical channel ID corresponding to the data, and transmits the processed data to the second node over the tunnel corresponding to the data.

In some implementations, in a case in which implementation of the first protocol stack and the second protocol stack is the foregoing manner 2 or manner 4; after the first node performs the transmission-related processing on the received data by using the first protocol stack, the first node determines a tunnel corresponding to the data based on a terminal device ID, a MAC entity ID, or a PDU session ID that corresponds to the data, and transmits the processed data to the second node over the tunnel corresponding to the data.

In step 402, the second node receives data transmitted by the first node, performs bearer-related processing on the received data by using the second protocol stack, and transmits the processed data to a core network.

In some implementations, in a case in which implementation of the first protocol stack and the second protocol stack is the foregoing manner 1 or manner 3, the second node receives the data transmitted by the first node over a tunnel, where the tunnel is determined by the first node based on a logical channel ID corresponding to the data.

In some implementations, in a case in which implementation of the first protocol stack and the second protocol stack is the foregoing manner 2 or manner 4, the second node receives the data transmitted by the first node over a tunnel, where the tunnel is determined by the first node based on a terminal device ID, a MAC entity ID, or a PDU session ID that corresponds to the data.

In step 403, the second node receives data transmitted by a core network, performs bearer-related processing on the received data by using the second protocol stack, and transmits the processed data to the first node.

In some implementations, in a case in which implementation of the first protocol stack and the second protocol stack is the foregoing manner 1 or manner 3, after performing the bearer-related processing on the received data by using the second protocol stack, the second node determines a tunnel corresponding to the data based on a logical channel ID corresponding to the data, and transmits the processed data to the first node over the tunnel corresponding to the data.

In some implementations, in a case in which implementation of the first protocol stack and the second protocol stack is the foregoing manner 2 or manner 4, after performing the bearer-related processing on the received data by using the second protocol stack, the second node determines a tunnel corresponding to the data based on a terminal device ID, a MAC entity ID, or a PDU session ID that corresponds to the data, and transmits the processed data to the first node over the tunnel corresponding to the data.

In step 404, the first node receives data transmitted by the second node, performs transmission-related processing on the received data by using the first protocol stack, and transmits the processed data to a terminal device.

In some implementations, in a case in which implementation of the first protocol stack and the second protocol stack is the foregoing manner 1 or manner 3, the first node receives the data transmitted by the second node over a tunnel, where the tunnel is determined by the second node based on a logical channel ID corresponding to the data. Further, a MAC entity of the first node determines the logical channel ID corresponding to the data based on a tunnel ID of a tunnel corresponding to the data, and multiplexes the data into a MAC PDU based on the logical channel ID corresponding to the data.

In some implementations, in a case in which implementation of the first protocol stack and the second protocol stack is the foregoing manner 2 or manner 4, the first node receives the data transmitted by the second node over a tunnel, where the tunnel is determined by the second node based on a terminal device ID, a MAC entity ID, or a PDU session ID that corresponds to the data.

To implement the foregoing communication method, a process of RRC connection setup and bearer setup needs to be performed. The following describes how to implement the process of RRC connection setup and bearer setup for different cases.

Solution 1: In some implementations, in a case in which the first node has a first RRC entity, the process of RRC connection setup and bearer setup includes the following steps 1 to 5.

In step 1, the first node receives first RRC signalling transmitted by a terminal device, and obtains a NAS message in the first RRC signalling by using the first RRC entity.

As an example, the first RRC signalling is a MSG5, for example, an RRC setup complete (RRCSetupComplete) message.

As an example, the first RRC signalling carries an initial NAS message, for example, a service request message.

In step 2, the first node carries the NAS message in a first message and transmits the first message to the second node, and the second node receives the first message transmitted by the first node, where the first message carries the NAS message.

As an example, the first message is a bearer setup request (BearerSetupRequest) message.

As an example, the first message carries an initial NAS message, for example, a service request message.

In step 3, the NAS message in the first message is forwarded by the second node to a core network by using a second message (that is, the second node forwards the NAS message to the core network by using the second message), and the second node receives PDU session setup information transmitted by the core network.

As an example, the second message is an initial UE message (INITIAL UE MESSAGE).

As an example, the second message carries an initial NAS message, for example, a service request message.

As an example, the PDU session setup information is carried in an initial context setup request (INITIAL CONTEXT SETUP REQUEST) message.

In step 4, the second node transmits a third message to the first node, and the first node receives the third message transmitted by the second node, where the third message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission.

As an example, the third message is a bearer setup response (BearerSetupResponse) message.

In step 5, the first node transmits a fourth message to the second node, where the fourth message carries a tunnel ID of one or more tunnels, and the one or more tunnels are used for downlink transmission.

As an example, the fourth message is a bearer setup confirmation (BearerSetupconfirmation) message.

In the foregoing solution, in a case in which the first protocol stack of the first node includes a MAC entity, a tunnel ID of each tunnel in the one or more tunnels is associated with one logical channel ID or one data bearer ID; or in a case in which the first protocol stack of the first node does not include a MAC entity, the tunnel configuration is used to configure one tunnel corresponding to a PDU session, where a tunnel ID of the one tunnel is associated with one PDU session ID; and the fourth message carries a tunnel ID of one tunnel, and the tunnel ID of the one tunnel is associated with one PDU session ID.

Solution 2: In some implementations, in a case in which the first node does not have a first RRC entity, the process of RRC connection setup and bearer setup includes the following steps 1 to 5.

In step 1, the first node receives first RRC signalling transmitted by a terminal device.

As an example, the first RRC signalling is a MSG5, for example, an RRC setup complete (RRCSetupComplete) message.

In step 2, the first node forwards the first RRC signalling to the second node, and the second node receives the first RRC signalling transmitted by the first node.

In step 3, the NAS message in the first RRC signalling is forwarded by the second node to a core network by using a fifth message (that is, the second node obtains the NAS message in the first RRC signalling by using a second RRC entity of the second node, and forwards the NAS message to the core network by using the fifth message), and the second node receives PDU session setup information transmitted by the core network.

As an example, the fifth message is an initial UE message (INITIAL UE MESSAGE).

As an example, the PDU session setup information is carried in an initial context setup request (INITIAL CONTEXT SETUP REQUEST) message.

In step 4, the second node transmits a sixth message to the first node, and the first node receives the sixth message transmitted by the second node, where the sixth message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission.

As an example, the sixth message is a UE context setup request (UE CONTEXT SETUP REQUEST) message.

In step 5, the first node transmits a seventh message to the second node, and the second node receives the seventh message transmitted by the first node, where the seventh message carries a tunnel ID of one or more tunnels, and the one or more tunnels are used for downlink transmission.

As an example, the seventh message is a UE context setup response (UE CONTEXT SETUP RESPONSE) message.

In the foregoing solution, in a case in which the first protocol stack of the first node includes a MAC entity, a tunnel ID of each tunnel in the one or more tunnels is associated with one logical channel ID or one data bearer ID; or in a case in which the first protocol stack of the first node does not include a MAC entity, the tunnel configuration is used to configure one tunnel corresponding to a PDU session, where a tunnel ID of the one tunnel is associated with one PDU session ID; and the seventh message carries a tunnel ID of one tunnel, and the tunnel ID of the one tunnel is associated with one PDU session ID.

It should be noted that the first node and the second node may communicate with each other by using a newly defined interface, for example, an XxAP interface.

The following describes a process of connection setup and bearer setup by using examples with reference to the four cases in the foregoing solution, which are shown in Table 1.

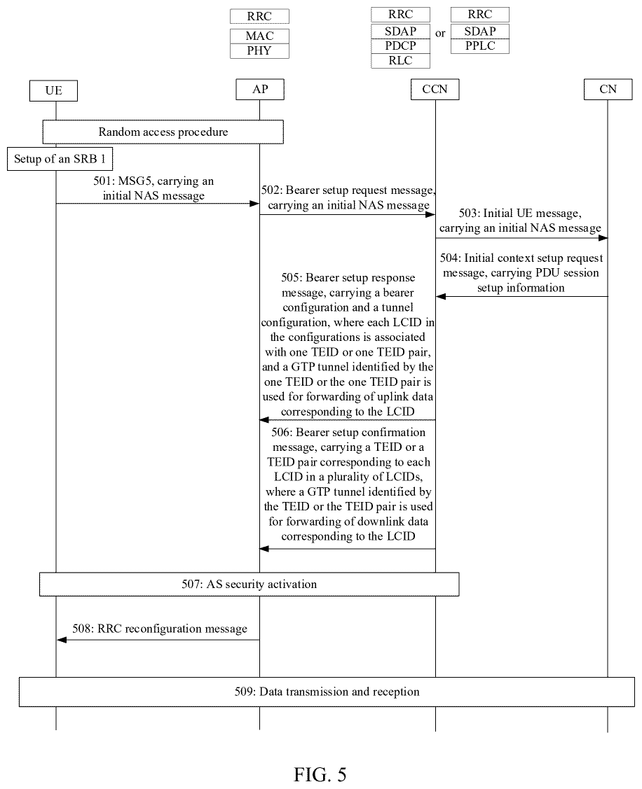

FIG. 5 is a schematic diagram of a process of connection setup and bearer setup corresponding to a case 1 according to an embodiment of this application. An AP has a PHY entity and a MAC entity, and a CCN has an RLC entity, a PDCP entity, and an SDAP entity, or has a PPCL entity and an SDAP entity. In addition, the AP has an RRC entity configured to process RRC signalling related to a transmission configuration (for example, a PHY configuration and a MAC configuration), and the CCN has an RRC entity configured to process RRC signalling related to a bearer. As shown in FIG. 5, the following steps 501 to 509 are included.

In step 501, a UE transmits a MSG5 to the AP, where the MSG5 carries an initial NAS message.

Before step 501, the UE and the AP perform a random access procedure with each other to complete setup of an SRB 1.

Herein, the MSG5 may be but is not limited to an RRC setup complete message. This message carries the initial NAS message, and the initial NAS message may be but is not limited to a service request message.

In step 502, the AP transmits a bearer setup request message to the CCN, where the bearer setup request message carries an initial NAS message.

Herein, the AP has an RRC entity, and therefore may process the MSG5, obtain the initial NAS message from the MSG5, carry the initial NAS message in the bearer setup request message, and transmit the bearer setup request message to the CCN. The initial NAS message may be but is not limited to a service request message.

In step 503, the CCN transmits an initial UE message to a CN, where the initial UE message carries an initial NAS message.

Herein, the CCN transmits the initial UE message to the CN through an NGAP interface, and the initial NAS message may be but is not limited to a service request message.

In step 504, the CN transmits an initial context setup request message to the CCN, where the initial context setup request message carries PDU session setup information.

In step 505, the CCN transmits a bearer setup response message to the AP, where the bearer setup response message carries a bearer configuration and a tunnel configuration, each LCID in the configurations is associated with one TEID or one TEID pair, and a GTP tunnel identified by the one TEID or the one TEID pair is configured to forward uplink data corresponding to the LCID.

Herein, the bearer configuration and the tunnel configuration may be one configuration (collectively referred to as a bearer configuration), or may be two separate configurations. The bearer configuration is used to configure one or more bearers corresponding to a PDU session, the tunnel configuration is used to configure one or more tunnels corresponding to a PDU session, the one or more tunnels are used for uplink transmission, and a tunnel ID of each tunnel in the one or more tunnels is associated with one logical channel ID or one data bearer ID.

In step 506, the AP transmits a bearer setup confirmation message to the CCN, where the bearer setup confirmation message carries a TEID or a TEID pair corresponding to each LCID in a plurality of LCIDs, and a GTP tunnel identified by the TEID or the TEID pair is configured to forward downlink data corresponding to the LCID.

In step 507, the UE, the AP, and the CCN perform AS security activation with each other.

In step 508, the AP transmits an RRC reconfiguration message to the UE.

In step 509, the UE, the AP, the CCN, and the CN perform data transmission and reception with each other.

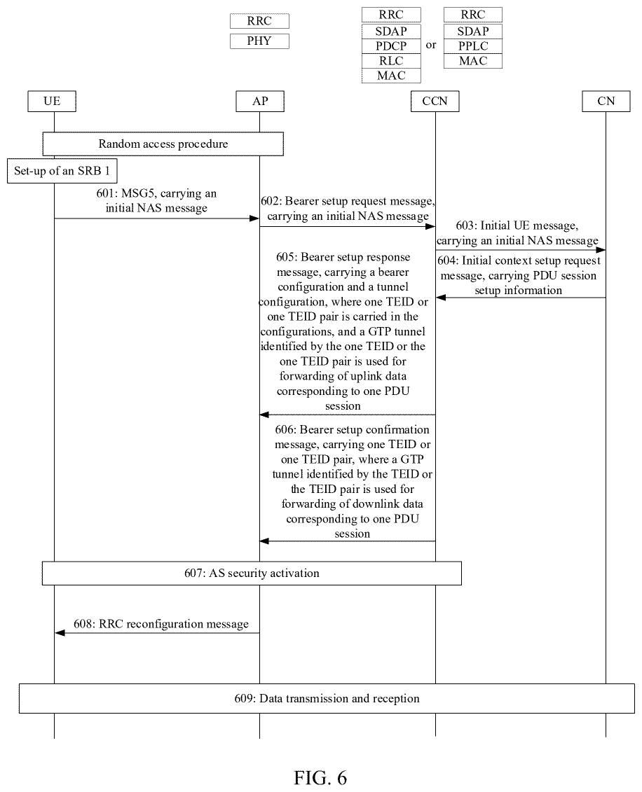

FIG. 6 is a schematic diagram of a process of connection setup and bearer setup corresponding to a case 4 according to an embodiment of this application. An AP has a PHY entity, and a CCN has a MAC entity, an RLC entity, a PDCP entity, and an SDAP entity, or has a MAC entity, a PPCL entity, and an SDAP entity. In addition, the AP has an RRC entity configured to process RRC signalling related to a transmission configuration (for example, a PHY configuration and a MAC configuration), and the CCN has an RRC entity configured to process RRC signalling related to a bearer. As shown in FIG. 6, the following steps 601 to 609 are included.

In step 601, a UE transmits a MSG5 to the AP, where the MSG5 carries an initial NAS message.

Before step 601, the UE and the AP perform a random access procedure with each other to complete setup of an SRB 1.

Herein, the MSG5 may be but is not limited to an RRC setup complete message. This message carries the initial NAS message, and the initial NAS message may be but is not limited to a service request message.

In step 602, the AP transmits a bearer setup request message to the CCN, where the bearer setup request message carries an initial NAS message.

Herein, the AP has an RRC entity, and therefore may process the MSG5, obtain the initial NAS message from the MSG5, carry the initial NAS message in the bearer setup request message, and transmit the bearer setup request message to the CCN. The initial NAS message may be but is not limited to a service request message.

In step 603, the CCN transmits an initial UE message to a CN, where the initial UE message carries an initial NAS message.

Herein, the CCN transmits the initial UE message to the CN through an NGAP interface, and the initial NAS message may be but is not limited to a service request message.

In step 604, the CN transmits an initial context setup request message to the CCN, where the initial context setup request message carries PDU session setup information.

In step 605, the CCN transmits a bearer setup response message to the AP, where the bearer setup response message carries a bearer configuration and a tunnel configuration, one TEID or one TEID pair is carried in the configurations, and a GTP tunnel identified by the one TEID or the one TEID pair is configured to forward uplink data corresponding to one PDU session.

Herein, the bearer configuration and the tunnel configuration may be one configuration (collectively referred to as a bearer configuration), or may be two separate configurations. The bearer configuration is used to configure one or more bearers corresponding to a PDU session, the tunnel configuration is used to configure one tunnel corresponding to a PDU session, the one tunnel is used for uplink transmission, and a tunnel ID of the one tunnel is associated with one PDU session ID or one MAC entity ID.

In step 606, the AP transmits a bearer setup confirmation message to the CCN, where the bearer setup confirmation message carries one TEID or one TEID pair, and a GTP tunnel identified by the TEID or the TEID pair is configured to forward downlink data corresponding to one PDU session.

In step 607, the UE, the AP, and the CCN perform AS security activation with each other.

In step 608, the AP transmits an RRC reconfiguration message to the UE.

In step 609, the UE, the AP, the CCN, and the CN perform data transmission and reception with each other.

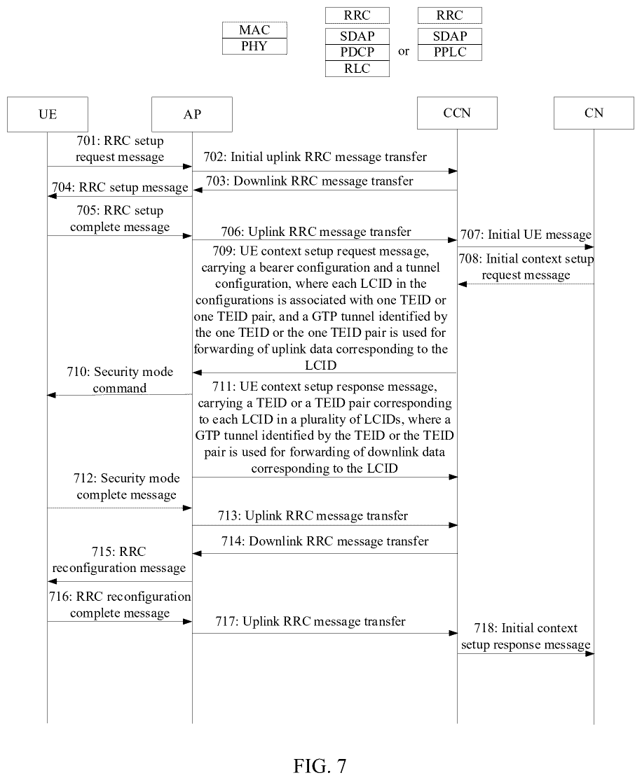

FIG. 7 is a schematic diagram of a process of connection setup and bearer setup corresponding to a case 3 according to an embodiment of this application. An AP has a MAC entity and a PHY entity, and a CCN has an RLC entity, a PDCP entity, and an SDAP entity, or has a PPCL entity and an SDAP entity. In addition, the CCN has an RRC entity configured to process all RRC signalling. As shown in FIG. 7, the following steps 701 to 718 are included. In step 701, a UE transmits an RRC setup request message to the AP.

In step 702, the AP performs an initial uplink RRC message transfer to the CCN.

In step 703, the CCN performs a downlink RRC message transfer to the AP.

In step 704, the AP transmits an RRC setup message to the UE.

In step 705, the UE transmits an RRC setup complete message to the AP.

In step 706, the AP performs an uplink RRC message transfer to the CCN.

Herein, that the AP performs an uplink RRC message transfer to the CCN may be understood as: the AP forwards the RRC setup complete message to the CCN.

In step 707, the CCN transmits an initial UE message to a CN.

In step 708, the CN transmits an initial context setup request message to the CCN.

In step 709, the CCN transmits a UE context setup request message to the AP, where the UE context setup request message carries a bearer configuration and a tunnel configuration, each LCID in the configurations is associated with one TEID or one TEID pair, and a GTP tunnel identified by the one TEID or the one TEID pair is configured to forward uplink data corresponding to the LCID.

Herein, the bearer configuration and the tunnel configuration may be one configuration (collectively referred to as a bearer configuration), or may be two separate configurations. The bearer configuration is used to configure one or more bearers corresponding to a PDU session, the tunnel configuration is used to configure one or more tunnels corresponding to a PDU session, the one or more tunnels are used for uplink transmission, and a tunnel ID of each tunnel in the one or more tunnels is associated with one logical channel ID or one data bearer ID.

In step 710, the AP transmits a security mode command to the UE.

In step 711, the AP transmits a UE context setup response message to the CCN, where the UE context setup response message carries a TEID or a TEID pair corresponding to each LCID in a plurality of LCIDs, and a GTP tunnel identified by the TEID or the TEID pair is configured to forward downlink data corresponding to the LCID.

In step 712, the UE transmits a security mode complete message to the AP.

In step 713, the AP performs an uplink RRC message transfer to the CCN.

In step 714, the CCN performs a downlink RRC message transfer to the AP.

In step 715, the AP transmits an RRC reconfiguration message to the UE.

In step 716, the UE transmits an RRC reconfiguration complete message to the AP.

In step 717, the AP performs an uplink RRC message transfer to the CCN.

In step 718, the CCN transmits an initial context setup response message to the CN.

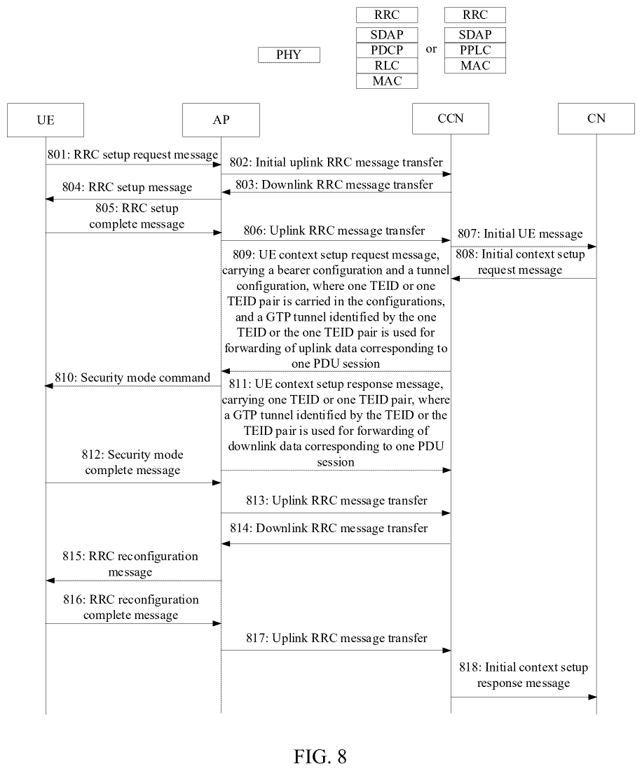

FIG. 8 is a schematic diagram of a process of connection setup and bearer setup corresponding to a case 2 according to an embodiment of this application. An AP has a PHY entity, and a CCN has a MAC entity, an RLC entity, a PDCP entity, and an SDAP entity, or has a MAC entity, a PPCL entity, and an SDAP entity. In addition, the CCN has an RRC entity configured to process all RRC signalling. As shown in FIG. 8, the following steps 801 to 818 are included.

In step 801, a UE transmits an RRC setup request message to the AP.

In step 802, the AP performs an initial uplink RRC message transfer to the CCN.

In step 803, the CCN performs a downlink RRC message transfer to the AP.

In step 804, the AP transmits an RRC setup message to the UE.

In step 805, the UE transmits an RRC setup complete message to the AP.

In step 806, the AP performs an uplink RRC message transfer to the CCN.

Herein, the AP performing an uplink RRC message transfer to the CCN may be understood as: the AP forwards the RRC setup complete message to the CCN.

In step 807, the CCN transmits an initial UE message to a CN.

In step 808, the CN transmits an initial context setup request message to the CCN.

In step 809, the CCN transmits a UE context setup request message to the AP, where the UE context setup request message carries a bearer configuration and a tunnel configuration, one TEID or one TEID pair is carried in the configurations, and a GTP tunnel identified by the one TEID or the one TEID pair is configured to forward uplink data corresponding to one PDU session.

Herein, the bearer configuration and the tunnel configuration may be one configuration (collectively referred to as a bearer configuration), or may be two separate configurations. The bearer configuration is used to configure one or more bearers corresponding to a PDU session, the tunnel configuration is used to configure one tunnel corresponding to a PDU session, the one tunnel is used for uplink transmission, and a tunnel ID of the one tunnel is associated with one PDU session ID or one MAC entity ID.

In step 810, the AP transmits a security mode command to the UE.

In step 811, the AP transmits a UE context setup response message to the CCN, where the UE context setup response message carries one TEID or one TEID pair, and a GTP tunnel identified by the TEID or the TEID pair is configured to forward downlink data corresponding to one PDU session.

In step 812, the UE transmits a security mode complete message to the AP.

In step 813, the AP performs an uplink RRC message transfer to the CCN.

In step 814, the CCN performs a downlink RRC message transfer to the AP.

In step 815, the AP transmits an RRC reconfiguration message to the UE.

In step 816, the UE transmits an RRC reconfiguration complete message to the AP.

In step 817, the AP performs an uplink RRC message transfer to the CCN.

In step 818, the CCN transmits an initial context setup response message to the CN.

In some implementations, the first node determines that the terminal device needs to be handed over from the first node to a third node, and the third node is also associated with the second node. The first node transmits a first command to the terminal device, where the first command is used to trigger the terminal device to be handed over from the first node to the third node, and the first command is a layer 1 command or a layer 2 command. In a process in which the terminal device is handed over from the first node to the third node, the terminal device is unnecessary to reconfigure a bearer-related configuration and/or an RRC configuration.

As an example, in the access network architecture shown in FIG. 2, when the UE is handed over from one AP (that is, an original AP) to another AP (that is, a target AP), a network side (for example, the original AP) delivers a layer 1 command or a layer 2 command (for example, DCI or a MAC CE) to the UE, where the command is used to trigger the UE perform handover. If the original AP and the target AP are associated with a same CCN, in a handover process, the UE and the network side are unnecessary to update a key, and are unnecessary to execute re-setup of an L2 entity (for example, a PDCP entity, an RLC entity, or a PPLC entity).

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations all fall within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application. For another example, without conflicts, embodiments described in this application and/or the technical features in embodiments may be randomly combined with the prior art, and the technical solutions obtained after the combination also fall within the protection scope of this application.

It should be further understood that, in the method embodiments of this application, sequence numbers of the foregoing processes do not mean execution sequences. The execution sequences of the processes shall be determined based on functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to a user equipment in a cell, “uplink” indicates that a transmission direction of a signal or data is a second direction from a user equipment in a cell to a station, and “sidelink” indicates that a transmission direction of a signal or data is a third direction from a user equipment 1 to a user equipment 2. For example, “downlink signal” indicates that a transmission direction of a signal is a first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” herein generally indicates an “or” relationship between the associated objects.

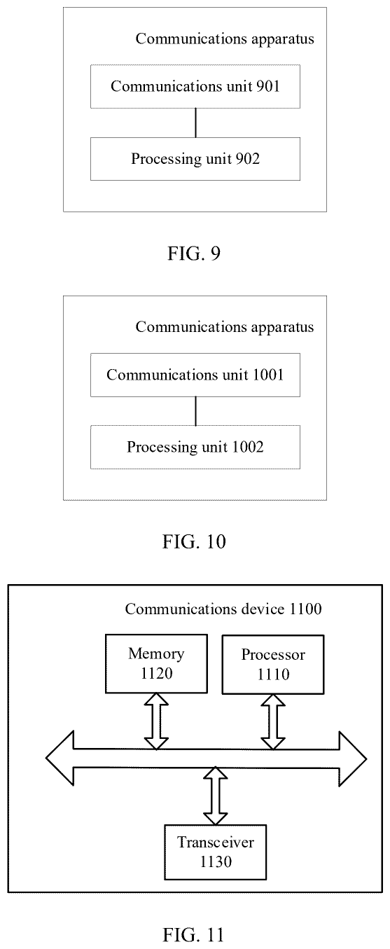

FIG. 9 is a schematic structural diagram 1 of a communications apparatus according to an embodiment of this application, applied to a first node in an access network architecture, where the first node is associated with a second node, the first node has a first protocol stack, the first protocol stack is a transmission-related protocol stack, the second node has a second protocol stack, and the second protocol stack is a bearer-related protocol stack. The apparatus includes a communications unit 901 and a processing unit 902, where the communications unit 901 is configured to receive data transmitted by a terminal device; the processing unit 902 is configured to perform transmission-related processing on the received data by using the first protocol stack; and the communications unit 901 is further configured to transmit the processed data to the second node; and/or the communications unit 901 is configured to receive data transmitted by the second node; the processing unit 902 is configured to perform transmission-related processing on the received data by using the first protocol stack; and the communications unit 901 is further configured to transmit the processed data to a terminal device.

In some implementations, the first protocol stack includes a MAC entity and a PHY entity, and the second protocol stack includes at least one of the following: an SDAP entity, a PDCP entity, or an RLC entity; or the first protocol stack includes a PHY entity, and the second protocol stack includes at least one of the following: an SDAP entity, a PDCP entity, an RLC entity, or a MAC entity; or the first protocol stack includes a MAC entity and a PHY entity, and the second protocol stack includes at least one of the following: an SDAP entity or a target entity, where the target entity has at least some of functions of a PDCP entity and/or an RLC entity; or
the first protocol stack includes a PHY entity, and the second protocol stack includes at least one of the following: an SDAP entity, a target entity, or a MAC entity, where the target entity has at least some of functions of a PDCP entity and/or an RLC entity.

In some implementations, in a case in which the first protocol stack includes a MAC entity, a tunnel used for data transmission between the first node and the second node is at a logical channel level or at a data bearer level.

In some implementations, one or more tunnels are established between the first node and the second node, and a tunnel ID of each tunnel is associated with one logical channel ID or one data bearer ID.

In some implementations, the communications unit 901 is configured to determine a tunnel corresponding to the data based on a logical channel ID corresponding to the data, and transmit the processed data to the second node over the determined tunnel corresponding to the data.

In some implementations, the communications unit 901 is configured to receive the data transmitted by the second node over a tunnel, where the tunnel is determined by the second node based on a logical channel ID corresponding to the data.

In some implementations, the processing unit 902 is configured to determine, by using a MAC entity, the logical channel ID corresponding to the data based on a tunnel ID of a tunnel corresponding to the data, and multiplex the data into a MAC PDU based on the logical channel ID corresponding to the data.

In some implementations, in a case in which the first protocol stack does not include a MAC entity, a tunnel used for data transmission between the first node and the second node is at a terminal device level, at a MAC entity level, or at a PDU session level.

In some implementations, one or more tunnels are established between the first node and the second node, and a tunnel ID of each tunnel is associated with a terminal device ID, a MAC entity ID, or a PDU session ID.

In some implementations, in a case in which the tunnel used for data transmission is at a terminal device level or at a MAC entity level, a MAC header corresponding to the data includes a PDU session ID and/or a MAC entity ID.

In some implementations, the communications unit 901 is configured to determine a tunnel corresponding to the data based on a terminal device ID, a MAC entity ID, or a PDU session ID that corresponds to the data, and transmit the processed data to the second node over the tunnel corresponding to the data.

In some implementations, the communications unit 901 is configured to receive the data transmitted by the second node over a tunnel, where the tunnel is determined by the second node based on a terminal device ID, a MAC entity ID, or a PDU session ID that corresponds to the data.

In some implementations, the first node further has a first RRC entity, and the second node further has a second RRC entity; or the first node does not have a first RRC entity, and the second node further has a second RRC entity.

In some implementations, in a case in which the first node has a first RRC entity, the first RRC entity is configured to process first-type RRC signalling, the second RRC entity is configured to process second-type RRC signalling, the first-type RRC signalling is RRC signalling related to a transmission configuration, and the second-type RRC signalling is RRC signalling related to a bearer.

In some implementations, in a case in which the first node does not have a first RRC entity, the second RRC entity is configured to process first-type RRC signalling and second-type RRC signalling, where the first-type RRC signalling is RRC signalling related to a transmission configuration, and the second-type RRC signalling is RRC signalling related to a bearer.

In some implementations, in a case in which the first node has a first RRC entity, the communications unit 901 is configured to: receive first RRC signalling transmitted by a terminal device, and obtain a NAS message in the first RRC signalling by using the first RRC entity; carry the NAS message in a first message, and transmit the first message to the second node, where the NAS message in the first message is forwarded by the second node to a core network by using a second message, and the second node receives PDU session setup information transmitted by the core network; receive a third message transmitted by the second node, where the third message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission; and transmit a fourth message to the second node, where the fourth message carries a tunnel ID of one or more tunnels, and the one or more tunnels are used for downlink transmission.

In some implementations, in a case in which the first node does not have a first RRC entity, the communications unit 901 is configured to: receive first RRC signalling transmitted by a terminal device; forward the first RRC signalling to the second node, where a NAS message in the first RRC signalling is forwarded by the second node to a core network by using a fifth message, and the second node receives PDU session setup information transmitted by the core network; receive a sixth message transmitted by the second node, where the sixth message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission; and transmit a seventh message to the second node, where the seventh message carries a tunnel ID of one or more tunnels, and the one or more tunnels are used for downlink transmission.

In some implementations, in a case in which the first protocol stack of the first node includes a MAC entity, a tunnel ID of each tunnel in the one or more tunnels is associated with one logical channel ID or one data bearer ID.

In some implementations, in a case in which the first protocol stack of the first node does not include a MAC entity, the tunnel configuration is used to configure one tunnel corresponding to the PDU session, and a tunnel ID of the one tunnel is associated with one PDU session ID; and the fourth message or a seventh message carries a tunnel ID of one tunnel, and the tunnel ID of the one tunnel is associated with one PDU session ID.

In some implementations, the processing unit 902 is configured to determine that the terminal device needs to be handed over from the first node to a third node, where the third node is also associated with the second node; and the communications unit 901 is configured to transmit a first command to the terminal device, where the first command is used to trigger the terminal device to be handed over from the first node to the third node, and the first command is a layer 1 command or a layer 2 command.

In some implementations, in a process in which the terminal device is handed over from the first node to the third node, the terminal device is unnecessary to reconfigure a bearer-related configuration and/or an RRC configuration.

A person skilled in the art should understand that related descriptions of the foregoing communications apparatus in this embodiment of this application may be understood with reference to related descriptions of the communication method in embodiments of this application.

FIG. 10 is a schematic structural diagram 2 of a communications apparatus according to an embodiment of this application, applied to a second node in an access network architecture, where the second node is associated with one or more nodes, each node in the one or more nodes has a first protocol stack, the first protocol stack is a transmission-related protocol stack, the second node has a second protocol stack, and the second protocol stack is a bearer-related protocol stack; and the apparatus includes a communications unit 1001 and a processing unit 1002, where
the communications unit 1001 is configured to receive data transmitted by a first node; the processing unit 1002 is configured to perform bearer-related processing on the received data by using the second protocol stack; and the communications unit 1001 is further configured to transmit the processed data to a core network; and/or
the communications unit 1001 is configured to receive data transmitted by a core network; the processing unit 1002 is configured to perform bearer-related processing on the received data by using the second protocol stack; and the communications unit 1001 is further configured to transmit the processed data to a first node, where the first node is associated with the second node.

In some implementations, the first protocol stack includes a MAC entity and a PHY entity, and the second protocol stack includes at least one of the following: an SDAP entity, a PDCP entity, or an RLC entity; or the first protocol stack includes a PHY entity, and the second protocol stack includes at least one of the following: an SDAP entity, a PDCP entity, an RLC entity, or a MAC entity; or the first protocol stack includes a MAC entity and a PHY entity, and the second protocol stack includes at least one of the following: an SDAP entity or a target entity, where the target entity has at least some of functions of a PDCP entity and/or an RLC entity; or the first protocol stack includes a PHY entity, and the second protocol stack includes at least one of the following: an SDAP entity, a target entity, or a MAC entity, where the target entity has at least some of functions of a PDCP entity and/or an RLC entity.

In some implementations, in a case in which the first protocol stack includes a MAC entity, a tunnel used for data transmission between the first node and the second node is at a logical channel level or at a data bearer level.

In some implementations, one or more tunnels are established between the first node and the second node, and a tunnel ID of each tunnel is associated with one logical channel ID or one data bearer ID.

In some implementations, the communications unit 1001 is configured to determine a tunnel corresponding to the data based on a logical channel ID corresponding to the data, and transmit the processed data to the first node over the tunnel corresponding to the data.

In some implementations, the communications unit 1001 is configured to receive the data transmitted by the first node over a tunnel, where the tunnel is determined by the first node based on a logical channel ID corresponding to the data.

In some implementations, in a case in which the first protocol stack does not include a MAC entity, a tunnel used for data transmission between the first node and the second node is at a terminal device level, at a MAC entity level, or at a PDU session level.

In some implementations, one or more tunnels are established between the first node and the second node, and a tunnel ID of each tunnel is associated with a terminal device ID, a MAC entity ID, or a PDU session ID.

In some implementations, in a case in which the tunnel used for data transmission is at a terminal device level or at a MAC entity level, a MAC header corresponding to the data includes a PDU session ID and/or a MAC entity ID.

In some implementations, the communications unit 1001 is configured to determine a tunnel corresponding to the data based on a terminal device ID, a MAC entity ID, or a PDU session ID that corresponds to the data, and transmit the processed data to the first node over the tunnel corresponding to the data.

In some implementations, the communications unit 1001 is configured to receive the data transmitted by the first node over a tunnel, where the tunnel is determined by the first node based on a terminal device ID, a MAC entity ID, or a PDU session ID that corresponds to the data.

In some implementations, the first node further has a first RRC entity, and the second node further has a second RRC entity; or the first node does not have a first RRC entity, and the second node further has a second RRC entity.

In some implementations, in a case in which the first node has a first RRC entity, the first RRC entity is configured to process first-type RRC signalling, the second RRC entity is configured to process second-type RRC signalling, the first-type RRC signalling is RRC signalling related to a transmission configuration, and the second-type RRC signalling is RRC signalling related to a bearer.

In some implementations, in a case in which the first node does not have a first RRC entity, the second RRC entity is configured to process first-type RRC signalling and second-type RRC signalling, where the first-type RRC signalling is RRC signalling related to a transmission configuration, and the second-type RRC signalling is RRC signalling related to a bearer.

In some implementations, in a case in which the first node has a first RRC entity, the communications unit 1001 is configured to: receive a first message transmitted by the first node, where the first message carries a NAS message; forward the NAS message to a core network by using a second message, and receive PDU session setup information transmitted by the core network; transmit a third message to the first node, where the third message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission; and receive a fourth message transmitted by the first node, where the fourth message carries a tunnel ID of one or more tunnels, and the one or more tunnels are used for downlink transmission.

In some implementations, in a case in which the first node does not have a first RRC entity, the communications unit 1001 is configured to: receive first RRC signalling transmitted by the first node; obtain a NAS message in the first RRC signalling by using a second RRC entity of the second node, forward the NAS message to a core network by using a fifth message, and receive PDU session setup information transmitted by the core network; transmit a sixth message to the first node, where the sixth message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission; and receive a seventh message transmitted by the first node, where the seventh message carries a tunnel ID of one or more tunnels, and the one or more tunnels are used for downlink transmission.

In some implementations, in a case in which the first protocol stack of the first node includes a MAC entity, a tunnel ID of each tunnel in the one or more tunnels is associated with one logical channel ID or one data bearer ID.

In some implementations, in a case in which the first protocol stack of the first node does not include a MAC entity, the tunnel configuration is used to configure one tunnel corresponding to a PDU session, and a tunnel ID of the one tunnel is associated with one PDU session ID; and the fourth message or a seventh message carries a tunnel ID of one tunnel, and the tunnel ID of the one tunnel is associated with one PDU session ID.

In some implementations, the second node belongs to a node pool, and all nodes in the node pool are connected to a same core network node. If the second node is faulty, all control plane connections and/or user plane connections under the second node are transferred to a fourth node in the node pool. Herein, at least one of a tunnel ID and a signalling connection ID allocated to the second node is unique in the node pool.

A person skilled in the art should understand that related descriptions of the foregoing communications apparatus in this embodiment of this application may be understood with reference to related descriptions of the communication method in embodiments of this application.

FIG. 11 is a schematic structural diagram of a communications device 1100 according to an embodiment of this application. The communications device may be a first node, or may be a second node. The communications device 1100 shown in FIG. 11 includes a processor 1110, and the processor 1110 may invoke a computer program from a memory and run the computer program to implement the method in embodiments of this application.

Optionally, as shown in FIG. 11, the communications device 1100 may further include a memory 1120. The processor 1110 may invoke a computer program from the memory 1120 and run the computer program to implement the method in embodiments of this application.

The memory 1120 may be a separate component independent of the processor 1110, or may be integrated into the processor 1110.

Optionally, as shown in FIG. 11, the communications device 1100 may further include a transceiver 1130. The processor 1110 may control the transceiver 1130 to communicate with another device, and specifically, may transmit information or data to the another device, or receive information or data transmitted by the another device.

The transceiver 1130 may include a transmitter and a receiver. The transceiver 1130 may further include an antenna, and a quantity of antennas may be one or more.

Optionally, the communications device 1100 may specifically be a first node in embodiments of this application, and the communications device 1100 may implement a corresponding procedure implemented by a first node in the methods according to embodiments of this application. For brevity, details are not described herein again.

Optionally, the communications device 1100 may specifically be a second node in embodiments of this application, and the communications device 1100 may implement a corresponding procedure implemented by a second node in the methods according to embodiments of this application. For brevity, details are not described herein again.

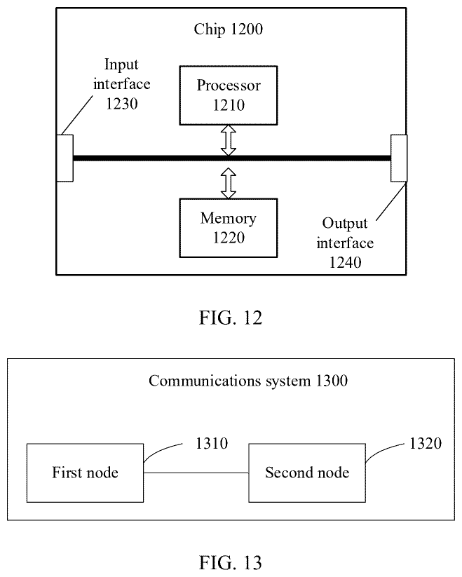

FIG. 12 is a schematic structural diagram of a chip according to an embodiment of this application. The chip 1200 shown in FIG. 12 includes a processor 1210, and the processor 1210 may invoke a computer program from a memory and run the computer program to implement the method in embodiments of this application.

Optionally, as shown in FIG. 12, the chip 1200 may further include a memory 1220. The processor 1210 may invoke a computer program from the memory 1220 and run the computer program to implement the method in embodiments of this application.

The memory 1220 may be a separate component independent of the processor 1210, or may be integrated into the processor 1210.

Optionally, the chip 1200 may further include an input interface 1230. The processor 1210 may control the input interface 1230 to communicate with another device or chip, and specifically, may obtain information or data transmitted by the another device or chip.

Optionally, the chip 1200 may further include an output interface 1240. The processor 1210 may control the output interface 1240 to communicate with another device or chip, and specifically, may output information or data to the another device or chip.

Optionally, the chip may be applied to a first node in embodiments of this application, and the chip may implement a corresponding procedure implemented by a first node in the methods according to embodiments of this application. For brevity, details are not described herein again.

Optionally, the chip may be applied to a second node in embodiments of this application, and the chip may implement a corresponding procedure implemented by a second node in the methods according to embodiments of this application. For brevity, details are not described herein again.

It should be understood that the chip mentioned in this embodiment of this application may alternatively be referred to as a system-level chip, a system chip, a chip system, a system-on-chip, or the like.

FIG. 13 is a schematic block diagram of a communications system 1300 according to an embodiment of this application. As shown in FIG. 13, the communications system 1300 includes a first node 1310 and a second node 1320.

The first node 1310 may be configured to implement a corresponding function implemented by a terminal device in the foregoing methods, and the second node 1320 may be configured to implement a corresponding function implemented by a first node in the foregoing methods. For brevity, details are not described herein again.

It should be understood that, a processor in the embodiment of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (Digital Signal Processor, DSP), an application-specific integrated circuit (Application Specific Integrated Circuit, ASIC), a field-programmable gate array (Field Programmable Gate Array, FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to a first node in embodiments of this application, and the computer program enables a computer to execute a corresponding procedure implemented by a first node in the methods according to embodiments of this application. For brevity, details are not described herein.

Optionally, the computer-readable storage medium may be applied to a second node in embodiments of this application, and the computer program causes a computer to execute a corresponding procedure implemented by a second node in the methods according to embodiments of this application. For brevity, details are not described herein again.

An embodiment of this application further provides a computer program product, including computer program instructions.

Optionally, the computer program product may be applied to a first node in embodiments of this application, and the computer program instructions cause the computer to execute a corresponding procedure implemented by a first node in the methods according to embodiments of this application. For brevity, details are not described herein again.

Optionally, the computer program product may be applied to a second node in embodiments of this application, and the computer program instructions cause the computer to execute a corresponding procedure implemented by a second node in the methods according to embodiments of this application. For brevity, details are not described herein again.

An embodiment of this application further provides a computer program.

Optionally, the computer program may be applied to a first node in embodiments of this application. When being run on a computer, the computer program causes the computer to execute a corresponding procedure implemented by a first node in the methods according to embodiments of this application. For brevity, details are not described herein.

Optionally, the computer program may be applied to a second node in embodiments of this application. When being run on a computer, the computer program causes the computer to execute a corresponding procedure implemented by a second node in the methods according to embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

Those skilled in the art may clearly understand that, for the purpose of convenient and brief description, for detailed working processes of the foregoing system, apparatus, and unit, refer to the corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to execute all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A communication method, applied to a first node in an access network architecture, wherein the first node is associated with a second node, the first node has a first protocol stack, the first protocol stack is a transmission-related protocol stack, the second node has a second protocol stack, and the second protocol stack is a bearer-related protocol stack; and the method comprises:
receiving, by the first node, data transmitted by a terminal device, performing transmission-related processing on the received data by using the first protocol stack, and transmitting the processed data to the second node; and/or
receiving, by the first node, data transmitted by the second node, perform transmission-related processing on the received data by using the first protocol stack, and transmitting the processed data to a terminal device.

2. The method according to claim 1, wherein
the first protocol stack comprises a medium access control MAC entity and a physical PHY entity, and the second protocol stack comprises at least one of following: a service data adaptation protocol SDAP entity, a packet data convergence protocol PDCP entity, or a radio link control RLC entity; or
the first protocol stack comprises a PHY entity, and the second protocol stack comprises at least one of following: an SDAP entity, a PDCP entity, an RLC entity, or a MAC entity; or
the first protocol stack comprises a MAC entity and a PHY entity, and the second protocol stack comprises at least one of following: an SDAP entity or a target entity, wherein the target entity has at least some of functions of a PDCP entity and/or an RLC entity; or
the first protocol stack comprises a PHY entity, and the second protocol stack comprises at least one of following: an SDAP entity, a target entity, or a MAC entity, wherein the target entity has at least some of functions of a PDCP entity and/or an RLC entity.

3. The method according to claim 2, wherein in a case in which the first protocol stack comprises a MAC entity, a tunnel used for data transmission between the first node and the second node is at a logical channel level or at a data bearer level.

4. The method according to claim 3, wherein one or more tunnels are established between the first node and the second node, and a tunnel ID of each tunnel of the one or more tunnels is associated with one logical channel ID or one data bearer ID.

5. The method according to claim 4, wherein the transmitting the processed data to the second node comprises:
determining, by the first node, a tunnel corresponding to the data based on a logical channel ID corresponding to the data, and transmitting the processed data to the second node over the determined tunnel corresponding to the data.

6. The method according to claim 4, wherein the receiving, by the first node, data transmitted by the second node comprises:
receiving, by the first node, the data transmitted by the second node over a tunnel, wherein the tunnel is determined by the second node based on a logical channel ID corresponding to the data.

7. The method according to claim 6, wherein the method further comprises:
determining, by the MAC entity of the first node, the logical channel ID corresponding to the data based on a tunnel ID of a tunnel corresponding to the data, and multiplexing the data into a MAC packet data unit PDU based on the logical channel ID corresponding to the data.

8. The method according to claim 2, wherein in a case in which the first protocol stack does not comprise a MAC entity, a tunnel used for data transmission between the first node and the second node is at a terminal device level, at a MAC entity level, or at a PDU session level.

9. The method according to claim 8, wherein one or more tunnels are established between the first node and the second node, and a tunnel ID of each tunnel of the one or more tunnels is associated with a terminal device ID, a MAC entity ID, or a PDU session ID.

10. The method according to claim 8, wherein in a case in which the tunnel used for data transmission is at a terminal device level or at a MAC entity level, a MAC header corresponding to the data comprises a PDU session ID and/or a MAC entity ID.

11. A first node, wherein the first node is arranged in an access network architecture, the first node is associated with a second node, the first node has a first protocol stack, the first protocol stack is a transmission-related protocol stack, the second node has a second protocol stack, and the second protocol stack is a bearer-related protocol stack; wherein the first node comprises a processor and a memory, the memory is configured to store a computer program, and the processor is configured to execute the computer program stored in the memory to cause the first node to perform a method including:
receiving data transmitted by a terminal device, performing transmission-related processing on the received data by using the first protocol stack, and transmitting the processed data to the second node; and/or
receiving data transmitted by the second node, performing transmission-related processing on the received data by using the first protocol stack, and transmitting the processed data to a terminal device.

12. The first node according to claim 11, wherein
the first protocol stack comprises a medium access control MAC entity and a physical PHY entity, and the second protocol stack comprises at least one of following: a service data adaptation protocol SDAP entity, a packet data convergence protocol PDCP entity, or a radio link control RLC entity; or
the first protocol stack comprises a PHY entity, and the second protocol stack comprises at least one of following: an SDAP entity, a PDCP entity, an RLC entity, or a MAC entity; or
the first protocol stack comprises a MAC entity and a PHY entity, and the second protocol stack comprises at least one of following: an SDAP entity or a target entity, wherein the target entity has at least some of functions of a PDCP entity and/or an RLC entity; or
the first protocol stack comprises a PHY entity, and the second protocol stack comprises at least one of following: an SDAP entity, a target entity, or a MAC entity, wherein the target entity has at least some of functions of a PDCP entity and/or an RLC entity.

13. The first node according to claim 12, wherein in a case in which the first protocol stack does not comprise a MAC entity, a tunnel used for data transmission between the first node and the second node is at a terminal device level, at a MAC entity level, or at a PDU session level;
and wherein one or more tunnels are established between the first node and the second node, and a tunnel ID of each tunnel of the one or more tunnels is associated with a terminal device ID, a MAC entity ID, or a PDU session ID.

14. The first node according to claim 13, wherein the transmitting the processed data to the second node comprises:
determining a tunnel corresponding to the data based on a terminal device ID, a MAC entity ID, or a PDU session ID that corresponds to the data, and transmitting the processed data to the second node over the tunnel corresponding to the data.

15. The first node according to claim 13, wherein the receiving data transmitted by the second node comprises:
receiving the data transmitted by the second node over a tunnel, wherein the tunnel is determined by the second node based on a terminal device ID, a MAC entity ID, or a PDU session ID that corresponds to the data.

16. The first node according to claim 11, wherein
the first node further has a first radio resource control RRC entity, and the second node further has a second RRC entity; or
the first node does not have a first RRC entity, and the second node further has a second RRC entity.

17. The first node according to claim 16, wherein in a case in which the first node has a first RRC entity,
the first RRC entity is configured to process first-type RRC signalling, the second RRC entity is configured to process second-type RRC signalling, the first-type RRC signalling is RRC signalling related to a transmission configuration, and the second-type RRC signalling is RRC signalling related to a bearer.

18. The first node according to claim 16, wherein in a case in which the first node does not have a first RRC entity,
the second RRC entity is configured to process first-type RRC signalling and second-type RRC signalling, wherein the first-type RRC signalling is RRC signalling related to a transmission configuration, and the second-type RRC signalling is RRC signalling related to a bearer.

19. The first node according to claim 11, wherein in a case in which the first node has a first RRC entity, the first node is further configured to:
receive first RRC signalling transmitted by a terminal device, and obtain a NAS message in the first RRC signalling by using the first RRC entity;
carry the NAS message in a first message, and transmit the first message to the second node, wherein the NAS message in the first message is forwarded by the second node to a core network by using a second message, and the second node receives PDU session setup information transmitted by the core network;
receive a third message transmitted by the second node, wherein the third message carries a bearer configuration and a tunnel configuration, the bearer configuration is used to configure one or more bearers corresponding to a PDU session, the tunnel configuration is used to configure one or more tunnels corresponding to a PDU session, and the one or more tunnels are used for uplink transmission; and
transmit a fourth message to the second node, wherein the fourth message carries a tunnel ID of one or more tunnels, and the one or more tunnels are used for downlink transmission.

20. The first node according to claim 19, wherein in a case in which the first protocol stack of the first node does not comprise a MAC entity,
the tunnel configuration is used to configure one tunnel corresponding to the PDU session, and a tunnel ID of the one tunnel is associated with one PDU session ID; and
the fourth message or a seventh message carries a tunnel ID of one tunnel, and the tunnel ID of the one tunnel is associated with one PDU session ID.
